(19) United States
(12) Patent Application Publication
(10) Pub. No.: US 2013/0330080 A1
(43) Pub. Date: Dec. 12, 2013

(54) Wavelength Division Multiplexing/De-Multiplexing Optical Assembly for High Speed Parallel Long Distance Transmission

(71) Applicant: InnoLight Technology (Suzhou) Ltd., Jiangsu (CN)

(72) Inventors: Weilong LI, Jiangsu (CN); Yuzhou SUN, Jiangsu (CN); Pan WANG, Jiangsu (CN); Peng HUANG, Jiangsu (CN); Gaohong SHI, Jiangsu (CN); Sheng LIU, Jiangsu (CN)

(21) Appl. No.: 13/836,413

(22) Filed: Mar. 15, 2013

(30) Foreign Application Priority Data
Jun. 6, 2012 (CN) 201210184192.7

(51) Int. Cl. H04J 14/02

(52) U.S. Cl. CPC H04J 14/02
USPC 398/79

(57) ABSTRACT

A wavelength division multiplexing/de-multiplexing optical assembly for high speed parallel long distance transmission, wherein, the output terminal of the laser group is provided with the silicon lens group, the optical adjusting plate group, the lower layer silicon lens array, the lower layer filter group, and the lower layer free space wavelength division multiplexer, the optical isolator, and the focusing lens arranged in turn; the output terminal of the focusing lens is coupled with an input optical fiber; an output optical fiber is coupled with the collimating lens; the output terminal of the collimating lens is coupled with a prism; the output terminal of the prism is provided with the upper layer free space wavelength division multiplexer, the upper layer filter group, the upper layer silicon lens array and the detector group arranged in turn. Thereby, multiplexing/de-multiplexing of optical signals is realized by use of filter groups.

### TECHNICAL FIELD

The present application relates to a wavelength division multiplexing/de-multiplexing optical assembly for high speed parallel long distance transmission, which belongs to the technical field of optical transceiver modules in optical communication.

### BACKGROUND OF THE INVENTION

With the ever-increasing of the transmission capacity in the communication field, the conventional transmission techniques have failed to meet the demands for transmission capacity and transmission speed. In the fields of data center application, as well as internet core node, education organization, search engine, large-scale web site, high performance computer, and so on, in order to avoid the insufficiency of the bandwidth resources of the central net, network operators and service providers are programming deployment of next generation internet protocol. The Institute of Electrical and Electronics Engineers (IEEE) has made the unified standard for 40 Gbps and 100 Gbps Ethernet under P802.3ba Internet Engineering Task Force.

However, with the rapid increasing of the demand for communication bandwidth, the existing communication system faces the two challenges of capacity and energy consumption. The research and development of the parallel optical module is increasing because it can provide larger bandwidth with smaller volume and lower energy consumption. The parallel optical module refers to a single module in which several lasers respectively align with several optical fibers, such as a four-channel short range transceiver module which is suitable for the short range high bandwidth computing and switching application, it is integrated with four independent transmitting and receiving channels, and is coupled to a multi-mode ribbon optical fiber with 12 channels. Thanks to the low power consumption resulting from the miniaturization and integration of devices, the heat generated and dissipated from the parallel optical module is much less than that from multiple discrete elements, thereby increasing the reliability of the device and the whole system. Therefore, in case a sub-component of the parallel optical module is to be aligned with a positioning component, a high accuracy and small errors are required so as to ensure the highest possible optical coupling efficiency.

### SUMMARY OF THE INVENTION

The objection of the present invention is to overcome the shortcomings of the prior art, and provide a wavelength division multiplexing/de-multiplexing optical assembly which can meet the requirements for high speed parallel long distance transmission, and effectively resolve the problems of the conventional wavelength division multiplexing/de-multiplexing optical assembly, such as large insert loss, low coupling efficiency, short transmission distance, low reliability, and difficulties for small outline package.

The objection of the present application is achieved by the following technical schemes:

A wavelength division multiplexing/de-multiplexing optical assembly for high speed parallel long distance transmission comprises a transmitting terminal, a transmitting terminal optical lens group, a receiving terminal optical lens group and a receiving terminal disposed in turn; the transmitting terminal is a laser group with a coarse wavelength division multiplexing wave length according to the provision of IEEE 802.3ba; the receiving terminal is a detector group with a coarse wavelength division multiplexing wave length according to the provision of IEEE 802.3ba; the transmitting terminal optical lens group comprises a silicon lens group, an optical adjusting plate group, a lower layer silicon lens array, a lower layer filter group, a lower layer free space wavelength division multiplexer, an optical isolator and a focusing lens; the receiving terminal optical lens group comprises a collimating lens, an upper layer free space wavelength division multiplexer, an upper layer filter group and an upper layer silicon lens array; wherein, the output terminal of the laser group is provided with the silicon lens group, the optical adjusting plate group, the lower layer silicon lens array, the lower layer filter group, and the lower layer free space wavelength division multiplexer, the optical isolator, and the focusing lens arranged in turn; the output terminal of the focusing lens is coupled with an input optical fiber; an output optical fiber is coupled with the collimating lens; the output terminal of the collimating lens is coupled with a prism; the output terminal of the prism is provided with the upper layer free space wavelength division multiplexer, the upper layer filter group, the upper layer silicon lens array and the detector group arranged in turn.

Preferably, with respect to the wavelength division multiplexing/de-multiplexing optical assembly for high speed parallel long distance transmission described above, wherein, the laser group is an array of lasers, of which effective illuminating areas are aligned on a same straight line with equal intervals.

More preferably, with respect to the wavelength division multiplexing/de-multiplexing optical assembly for high speed parallel long distance transmission described above, wherein, the detector group is an array of detectors, of which effective receiving areas are aligned on a same straight line with equal intervals.

More preferably, with respect to the wavelength division multiplexing/de-multiplexing optical assembly for high speed parallel long distance transmission described above, wherein, the optical adjusting plate group comprises at least one optical adjusting plate, and an adjusting cap for supporting the optical adjusting plate; the adjusting cap is in the shape of a hemispherical or a cube.

More preferably, with respect to the wavelength division multiplexing/de-multiplexing optical assembly for high speed parallel long distance transmission described above, wherein, both of the upper layer filter group and the lower layer filter group are bandpass filter group.

More preferably, with respect to the wavelength division multiplexing/de-multiplexing optical assembly for high speed parallel long distance transmission described above, wherein, the upper layer free space wavelength division multiplexer is fixed in the positioning groove of the housing, the main body of the upper layer free space wavelength division multiplexer is a prism, which comprises two surfaces for light transmission path, wherein one of the surfaces is coated with a total reflection film, and is provided with a window for incidence or exit of optical signal, and the other surface is combined with the upper layer filter group.

More preferably, with respect to the wavelength division multiplexing/de-multiplexing optical assembly for high speed parallel long distance transmission described above, wherein, the lower layer free space wavelength division multiplexer is fixed in the positioning groove of the housing, the main body of the upper layer free space wavelength division multiplexer is a prism, which comprises two surfaces for light transmission path, wherein one of the surfaces is coated with a total reflection film, and is provided with a window for incidence or exit of optical signal, and the other surface is combined with the upper layer filter group.

More preferably, with respect to the wavelength division multiplexing/de-multiplexing optical assembly for high speed parallel long distance transmission described above, wherein, the collimating lens, the silicon lens group and the optical adjusting plate group are coated with anti-reflection film.

### BRIEF DESCRIPTION OF THE DRAWINGS

The technical solutions of the present invention will be further described in conjunction with the accompanying drawings:

FIG. 1 is a schematic diagram illustrating the structure of the transmitting terminal and the principle of wavelength division multiplexing optical path of the present invention;

FIG. 2 is a schematic diagram illustrating the structure of the receiving terminal and the principle of wavelength division de-multiplexing optical path of the present invention;

FIG. 3 is a schematic diagram of the internal structure of the transmitting terminal of the present invention;

FIG. 4 is a schematic diagram of the internal structure of the receiving terminal of the present invention;

FIG. 5 is a transmission characteristic curve of the filter of the present invention.

The elements in the figures are denoted as follows:

laser group; 2. silicon lens group; 3. optical adjusting plate group;

4. lower layer silicon lens array; 5. lower layer filter group;

6. lower layer free space wavelength division multiplexer;

7. optical isolator; 8. focusing lens;

10. collimating lens; 11. upper layer free space wavelength division multiplexer;

12. upper layer filter group; 13. upper layer silicon lens array;

14. detector group; 15. housing; 16. prism.

### DETAILED DESCRIPTION OF THE PREFERRED EMBODIMENT

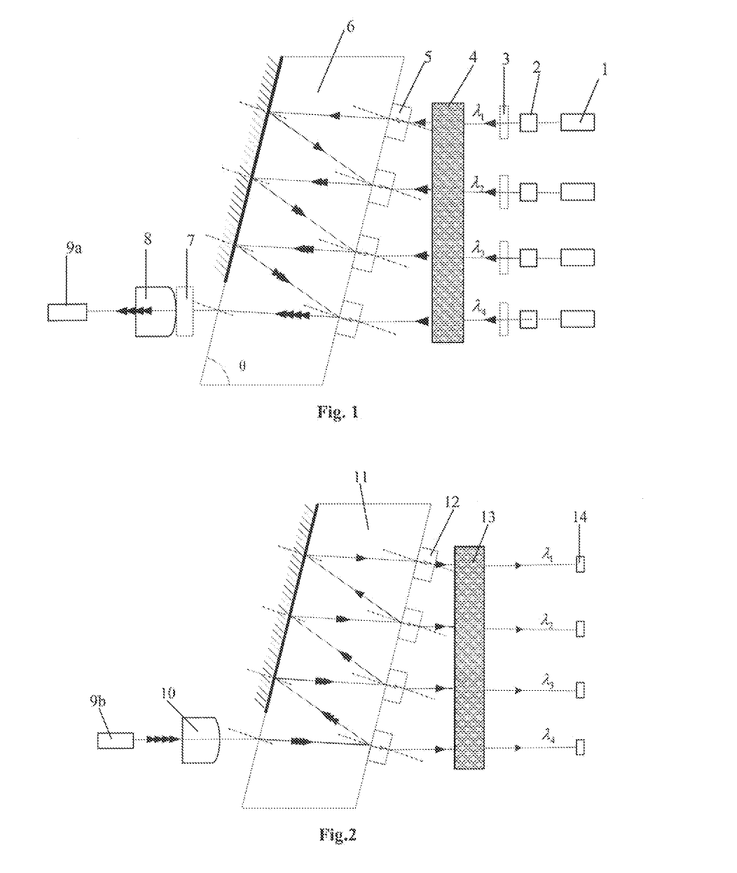

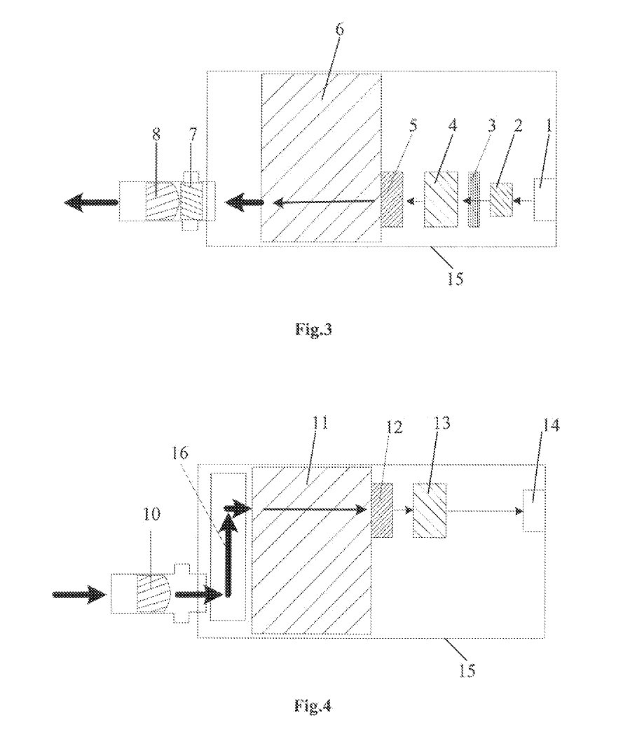

A wavelength division multiplexing/de-multiplexing optical assembly for high speed parallel long distance transmission comprises a transmitting terminal, a transmitting terminal optical lens group, a receiving terminal optical lens group and a receiving terminal disposed in turn. As shown in FIGS. 1 and 2, the transmitting terminal is a laser group 1 with a coarse wavelength division multiplexing wave length according to the provision of IEEE 802.3ba; the receiving terminal is a detector group 14 with a coarse wavelength division multiplexing wave length according to the provision of IEEE 802.3ba; the transmitting terminal optical lens group comprises a silicon lens group 2, an optical adjusting plate group 3, a lower layer silicon lens array 4, a lower layer filter group 5, a lower layer free space wavelength division multiplexer 6, an optical isolator 7 and a focusing lens 8; the receiving terminal optical lens group comprises a collimating lens 10, an upper layer free space wavelength division multiplexer 11, an upper layer filter group 12 and an upper layer silicon lens array 13; all of the collimating lens 10, the silicon lens group 2 and the optical adjusting plate group 3 are coated with anti-reflection film; the output terminal of the laser group 1 is provided with the silicon lens group 2, the optical adjusting plate group 3 and the lower layer silicon lens array 4, the lower layer filter group 5, and the lower layer free space wavelength division multiplexer 6, the optical isolator 7, and the focusing lens 8 arranged in turn; the output terminal of the focusing lens 8 is coupled with the input optical fiber 9a; the output optical fiber 9b is coupled with the collimating lens 10; the output terminal of the collimating lens 10 is coupled with a prism 16; the output terminal of the prism 16 is provided with the upper layer free space wavelength division multiplexer 11, the upper layer filter group 12, the upper layer silicon lens array 13, and the detector group 14 arranged in turn.

As shown in FIG. 3, the laser group 1 is an array of lasers, of which effective illuminating areas are aligned on a same straight line with equal intervals.

The optical adjusting plate group 3 comprises at least one optical adjusting plate, and an adjusting cap for supporting the optical adjusting plate; the adjusting cap is in the shape of a hemispherical or a cube; the optical path can be micro-adjusted by using the “optical lever” principle.

The lower layer silicon lens array 4 comprises a focusing lens, a collimating lens and a focusing lens arranged in turn. Optical signal from the transmitting terminal is focused by a focusing lens, collimated by a collimating lens, then multiplexed, and coupled into an optical fiber or other optical paths via a focusing lens.

The lower layer filter group 5 is a bandpass filter group.

The lower layer free space wavelength division multiplexer 6 fixed in the positioning groove of the housing 15 comprises two surfaces for light transmission path, wherein one of the surfaces is coated with a total reflection film, and is provided with a window for incidence or exit of optical signal, and the other surface is combined with the upper layer filter group 5.

Each of the filters corresponds to optical signal with a specific wavelength, and is disposed in a suitable position in the light transmission path, the lower layer free space wavelength division multiplexer 6 has functions of wavelength division multiplexing and de-multiplexing, the wavelength division multiplexing and de-multiplexing of an optical signal can be realized by using at least one or two or more filter array wavelength division multiplexers.

The optical isolator 7 is disposed in a suitable position in the light transmission path, for reducing the effect of reflection light on laser.

Positioning grooves for various components are provided inside the housing 15, which effectively reduce the difficulty in manufacturing the optical components.

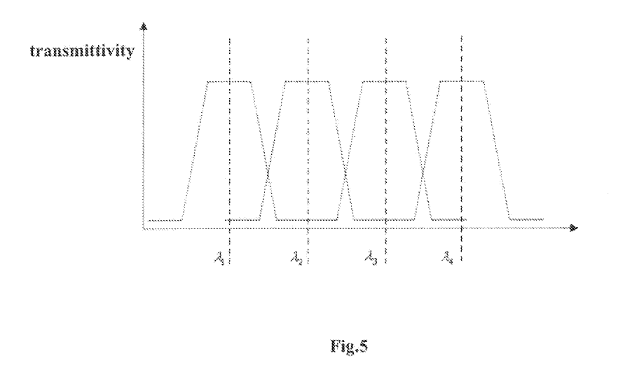

As shown in FIG. 4, the receiving terminal optical lens group comprises the upper layer silicon lens array 13, the upper layer filter group 12 and the upper layer free space wavelength division multiplexer 11; the output terminal of the collimating lens 10 is coupled with the prism 16; the output terminal of the prism 16 is provided with the upper layer free space wavelength division multiplexer 11, wherein the prism 16 is used for directing the optical signal into the upper layer free space wavelength division multiplexer 11, and realizing the de-multiplexing of the optical signal; the upper layer free space wavelength division multiplexer 11 realizes the shift of the incidence beam from other optical path plane to an optical path plane of the receiving terminal. The upper layer free space wavelength division multiplexer 11 fixed in the positioning groove of the housing 15 comprises two surfaces for light transmission path, wherein one of the surfaces is coated with a total reflection film, and is provided with a window for incidence or exit of optical signal, and the other surface is combined with the upper layer filter group 12, for realizing the de-multiplexing of optical signal.

All filters of the upper layer filter group 12 are bandpass filters.

The upper layer silicon lens array 13 is used for directing optical signal to couple with the detector 14.

The detector group 14 is an array of detectors, of which effective receiving areas are aligned on a same straight line with equal intervals.

The free space wavelength division multiplexer is divided into two layers, that is, the lower layer free space wavelength division multiplexer 6 and the upper layer free space wavelength division multiplexer 11, the two layers may be separate or integral.

The constitution and structure of the wavelength division multiplexing/de-multiplexing transmitting terminal optical assembly and the principle of wavelength division multiplexing optical path are illustrated in FIG. 1. Firstly, with respect to the laser group 1 with a coarse wavelength division multiplexing wave length according to the provision of IEEE 802.3ba, effective illuminating areas of the lasers are aligned on a same straight line with equal intervals. The multi-channel optical signals generated by the laser group 1 are coupled into a filter array wavelength division multiplexer by passing through a coaxial far center optical path group consisting of the silicon lens group 2, and after being multiplexed by the filter array wavelength division multiplexer, the multi-channel signals are multiplexed into a one-channel signal, and then coupled via a focusing lens into a single optical fiber, thereby realizing the wavelength division multiplexing of the optical signals. Wherein, the optical adjusting plate group 3 performs micro-adjustment in the coupling of optical paths, and is composed of the upper transparent material and the lower adjusting cap, the transparent material and the adjusting cap may be separate or integral. The optical adjusting plate group 3 is disposed in a suitable position in the light transmission path, and enlarges the mechanical micro-adjustment to be performed by using the principle of “optical lever”, so that the micro-adjustment to the optical paths can be performed with a real clip, moreover, the optical adjusting plate is not sensitive to direction Z of the optical path, which plays an important role in stabilizing the optical path. The bandpass filter is a film filter, the transmission characteristic curve thereof is shown in FIG. 5. The optical signals generated by the corresponding lasers can pass through the filter group. Taking the optical path of the fourth output channel for example, the optical signal with the wavelength of λ₄ passes through the bandpass filter, enters into the filter array wavelength division multiplexer, and couples with the reflection optical signals with the wavelengths of λ₁, λ₂ and λ₃ forming one optical signal for transmission. The optical paths of the remaining channels can be done in the same manner. It should be noted that a window is disposed on the total reflection surface of the filter array wavelength division multiplexer, for transmitting the optical signals.

The constitution and structure of the wavelength division multiplexing/de-multiplexing receiving terminal optical assembly and the principle of wavelength division multiplexing optical path are illustrated in FIG. 2. With respect to the detector group 14 with a coarse wavelength division multiplexing wave length according to the provision of IEEE 802.3ba, effective receiving areas of the detectors are aligned on a same straight line with equal intervals, the wavelength division multiplexing optical signal is transmitted through a single optical fiber, enters into the wavelength division multiplexing/de-multiplexing optical component, and after being coupled by the collimating lens, the signal firstly enters into the filter array wavelength division de-multiplexer, and then after being de-multiplexed by the filter array wavelength division de-multiplexer, one channel signal is de-multiplexed into multi-channel signals for transmission, and then after being focused by the upper layer silicon lens array 13, the signals from different channels are received by the detectors, thereby realizing the function of de-multiplexing. The bandpass filter is a film filter, the transmission characteristic curve thereof is shown in FIG. 5. The optical signals with the corresponding wavelengths can pass through the filter group. Taking the optical path of the first input channel for example, the optical signals with the wavelengths of λ₁, λ₂, λ₃ and λ₄ enter into the wavelength division multiplexing/de-multiplexing receiving terminal optical assembly through optical fibers, and the optical signals with the wavelengths of λ₁, λ₂ and λ₃ can not pass through the bandpass filter in the first input channel, only the signal with the wavelength of λ₄ can pass through the channel, the optical signals with the wavelengths of λ₁, λ₂ and λ₃ enter into the next channel after reflection, the optical paths of the remaining channels can be done in the same manner, realizing the function of wavelength division de-multiplexing. It should be noted that there is a window on the total reflection surface of the filter array wavelength division multiplexer, for transmitting the optical signals.

In summary, with respect to the wavelength division multiplexing/de-multiplexing optical assembly for high speed parallel long distance transmission, the function of wavelength division multiplexing/de-multiplexing is realized by using a filter array structure, and in each channel of the transmitting terminal, the optical adjusting plate is used to perform micro-adjustment to the light transmission path by using the principle of “optical lever”, which is beneficial to the coupling and stability of the optical paths. Moreover, in each channel of the transmitting terminal, the optical signals are coupled into the single mode optical fibers via the lens group, the coupling efficiency is high and up to 80%, which is very helpful for the long distance transmission of the optical signal; the receiving terminal optical components realize the de-multiplexing of optical signal by using the filter array structure. The wavelength division multiplexing/de-multiplexing optical assembly of the present invention uses a high density and small space packaged chip, moreover, the receiving terminal and the transmitting terminal are arranged in two layers, i.e., an upper layer and a lower layer, which largely reduce the volume, and is very helpful to realize the miniaturization of the parallel optical transceiver modules. Moreover, the “optical lever” function of the optical adjusting plate reduces the precision requirements for chip placement, simplifies the process of design and assembling, and greatly reduces production cost. The wavelength division multiplexing/de-multiplexing optical assembly can be produced with the existing manufacturing technology of optical components, and is very suitable for batch production. The present invention overcomes the shortcomings of discrete components of the prior art, such as large volume, large loss, high requirement for package accuracy, high production cost, and provides a pluggable parallel optical transceiver module with high alignment accuracy and low operation error.

It should be understood by those skilled in the art that what described above are preferred embodiments of the present invention, various modifications and replacements may be made therein without departing from the principle of the present invention, which should also be seen in the scope of the present invention.

What is claimed is:

1. A wavelength division multiplexing/de-multiplexing optical assembly for high speed parallel long distance transmission, comprising a transmitting terminal, a transmitting terminal optical lens group, a receiving terminal optical lens group and a receiving terminal disposed in turn;
the transmitting terminal is a laser group with a coarse wavelength division multiplexing wave length according to the provision of IEEE 802.3ba; the receiving terminal is a detector group with a coarse wavelength division multiplexing wave length according to the provision of IEEE 802.3ba;
the transmitting terminal optical lens group comprises a silicon lens group, an optical adjusting plate group, a lower layer silicon lens array, a lower layer filter group, a lower layer free space wavelength division multiplexer, an optical isolator and a focusing lens; the receiving terminal optical lens group comprises a collimating lens, an upper layer free space wavelength division multiplexer, an upper layer filter group and an upper layer silicon lens array;
wherein, the output terminal of the laser group is provided with the silicon lens group, the optical adjusting plate group, the lower layer silicon lens array, the lower layer filter group, and the lower layer free space wavelength division multiplexer, the optical isolator, and the focusing lens arranged in turn;
the output terminal of the focusing lens is coupled with an input optical fiber; an output optical fiber is coupled with the collimating lens; the output terminal of the collimating lens is coupled with a prism;
the output terminal of the prism is provided with the upper layer free space wavelength division multiplexer, the upper layer filter group, the upper layer silicon lens array and the detector group arranged in turn.

2. The wavelength division multiplexing/de-multiplexing optical assembly for high speed parallel long distance transmission according to claim 1, wherein, the laser group is an array of lasers, of which effective illuminating areas are aligned on a same straight line with equal intervals.

3. The wavelength division multiplexing/de-multiplexing optical assembly for high speed parallel long distance transmission according to claim 1, wherein, the detector group is an array of detectors, of which effective receiving areas are aligned on a same straight line with equal intervals.

4. The wavelength division multiplexing/de-multiplexing optical assembly for high speed parallel long distance transmission according to claim 1, wherein, the optical adjusting plate group comprises at least one optical adjusting plate, and an adjusting cap for supporting the optical adjusting plate, the adjusting cap is in the shape of a hemispherical or a cube.

5. The wavelength division multiplexing/de-multiplexing optical assembly for high speed parallel long distance transmission according to claim 1, wherein, both of the upper layer filter group and the lower layer filter group are bandpass filter group.

6. The wavelength division multiplexing/de-multiplexing optical assembly for high speed parallel long distance transmission according to claim 1, wherein, the upper layer free space wavelength division multiplexer is fixed in the positioning groove of a housing, a main body of the upper layer free space wavelength division multiplexer is a prism, which comprises two surfaces for light transmission path, wherein one of the surfaces is coated with a total reflection film, and is provided with a window for incidence or exit of optical signal, and the other surface is combined with the upper layer filter group.

7. The wavelength division multiplexing/de-multiplexing optical assembly for high speed parallel long distance transmission according to claim 1, wherein, the lower layer free space wavelength division multiplexer is fixed in the positioning groove of a housing, a main body of the upper layer free space wavelength division multiplexer is a prism, which comprises two surfaces for light transmission path, wherein one of the surfaces is coated with a total reflection film, and is provided with a window for incidence or exit of optical signal, and the other surface is combined with the upper layer filter group.

8. The wavelength division multiplexing/de-multiplexing optical assembly for high speed parallel long distance transmission according to claim 1, wherein, the collimating lens, the silicon lens group and the optical adjusting plate group are coated with anti-reflection film.
